(19) United States
(12) Patent Application Publication
(10) Pub. No.: US 2006/0270737 A1
(43) Pub. Date: Nov. 30, 2006

(54) Menthol propyleneglycol-carbonate and analogs thereof as insect pest repellents

(76) Inventor: Jonathan R. Matias, Hollis, NY (US)

Correspondence Address: BROOKS KUSHMAN P.C., 1000 TOWN CENTER, TWENTY-SECOND FLOOR, SOUTHFIELD, MI, 48075, US

(21) Appl. No.: 10/595,143

(22) PCT Filed: Aug. 18, 2004
(86) PCT No.: PCT/US04/26900

§ 371 Date: Mar. 3, 2006

Related U.S. Application Data
(60) Provisional application No. 60/500,392, filed on Sep. 5, 2003.

(51) Int. Cl. A01N 37/02; A01N 37/18

(52) U.S. Cl. 514/546; 514/613

(57) ABSTRACT

Menthol propyleneglycol-carbonate, analogs thereof and compositions containing such compounds are useful as insect repellents.

### CROSS-REFERENCE TO RELATED APPLICATION

This application claims the benefit of U.S. Provisional Application No. 60/500,392, filed Sep. 5, 2003.

### BACKGROUND OF THE INVENTION

The present invention relates to the insect repellent effects of menthol propyleneglycol-carbonate and analogs thereof.

Menthol is a natural product which is obtainable from peppermint oil and other mint oils. Menthol and various analogs thereof, such as (−)-isopulegol, N-ethyl-p-menthane-3-carboxyamide and p-methane-3,8 diol, are used in commerce as cooling agents. These compounds impart a cooling sensation to a variety of products, for example, cosmetics, perfumes, personal care products, oral hygiene products, confectionary, cigarettes, cough drops, nasal inhalants and the like. See, also U.S. Pat. No. 5,703,123 to Pelzer, et al.

Menthol has also been applied as a topical antipruitic, and in veterinary medicine as a mild local anesthetic and antiseptic, as well as an internal carminative and gastric sedative. See also, U.S. Pat. No. 5,124,320 to Ivy et al.

Menthol and various of its analogs have also been found to possess anti-fouling activity. See published International Patent Application No. PCT/01/40929.

Menthol has been disclosed as one of several components of a miticide in JP 4305505A, and as the essential constituent of a cockroach repellent in JP 55104202A.

Certain analogs and derivatives of menthol have also been disclosed as effective repellents against noxious insects, such as mosquitoes, ticks and mites. These include p-menthane-3,8-diol, as described in U.S. Pat. No. 5,959,161 to Akiyama et al., and the menthyl ester of pyrrolidone-5-carboxylic acid, as described in U.S. Pat. No. 6,451,884 to Watkins et al.

Research into the effectiveness of naturally-occurring chemical compounds for use as insect repellents and in other applications has been motivated, at least in part, by a growing public concern over the possible health risks associated with products of this type that contain synthetic chemicals as active agents. Consequently, efforts continue toward the development of safe and effective insect repellents based on natural compounds.

### SUMMARY OF THE INVENTION

It has now been discovered, in accordance with the present invention, that carbonic acid derivatives of menthol and various analogs thereof are very effective insect repellents.

In accordance with one aspect of the present invention, there is provided a method for repelling insects from a site, which comprises applying to the site an insect repelling amount of a compound of the formula: 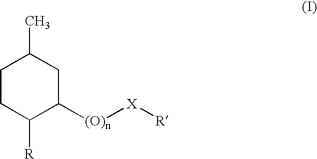
wherein R represents a straight or branched chain, substituted or unsubstituted lower alkyl radical, or a straight or branched chain, substituted or unsubstituted lower alkenyl radical; X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0.

The method is effective for repelling insect pests from animals, e.g. humans and livestock, plants, plant parts, seeds and from inanimate objects, as well.

In accordance with another aspect of the present invention, an insect repellent composition is provided which comprises a compound of Formula I, above, and a sustained release carrier.

The compounds described herein may also be used as a component of cosmetic or personal care compositions, as well as household cleaning compositions, in order to impart insect repellent activity to such compositions.

The present invention may also be embodied in articles of manufacture comprising fabrics, e.g. mosquito netting, in which is incorporated a compound of Formula I, above.

The present invention further provides coating compositions, e.g. for architectural and industrial coating applications, including a compound of Formula I above, and methods of using such compositions to prevent infestation of structural surfaces by insect pests.

As will appear in the detailed description that follows, compounds of Formula I, above, have utility as repellents against a wide variety of insect pests.

In published International Application PCT/IN02/00228 menthol propyleneglycol-carbonate and menthol ethyleneglycol-carbonate are disclosed as ingredients of a “cooling cum moisturizing agent” for use as an optional component in an anti-itch formulation. Insofar as is known, however, the compounds described herein as being useful for the practice of this invention have not previously been disclosed or suggested as having insect repellent activity.

### BRIEF DESCRIPTION OF THE DRAWINGS

FIG. 1 is a bar graphic of experimental data showing dose dependent inhibition of mosquito biting by application of a lotion containing various concentrations of racemic menthol propyleneglycol-carbonate.

FIG. 2 is a bar graph showing the repellent effect provided by menthol propyleneglycol-carbonate against the common housefly (Musca domestica) alighting on raw beef, as a function of the concentration of menthol propyleneglycol-carbonate applied to the beef.

FIG. 3 is a bar graph showing the superior repellent effect provided by menthol propyleneglycol-carbonate in combination with DEET, on the one hand, and citronella, on the other hand, against mosquito biting activity, as compared to menthol propyleneglycol-carbonate alone, DEET above and citronella alone. A synergistic repellent effect was obtained with the combination of menthol propyleneglycol-carbonate and DEET.

### DETAILED DESCRIPTION OF THE INVENTION

Compounds used in the practice of this invention are available from commercial sources, including Symrise & Co KG and Takasago International USA, among others. The menthol carbonate derivatives may, if desired, be prepared from readily available starting materials, in the manner described in U.S. Pat. No. 5,703,123 to Pelzer, et al. and U.S. Pat. No. 3,419,543 to Mold, et al.

The following definitions apply with reference to compounds encompassed by Formula I, above:

The term “alkyl” refers to straight- or branched-chain unsubstituted alaphatic hydrocarbon groups of 1-12 carbon atoms. Similarly, the term “alkyl”, when used in combination form to name a substituent such as “hydroxyalkyloxy”, “hydroxyalkyl”, “alkylamine” or the like, refers to a straight- or branched-chain alaphatic hydrocarbon group of 1-12 carbon atoms. The expression “lower alkyl” refers to unsubstituted, straight- or branched-chain alkyl groups of 1-6 carbon atoms.

The term “substituted alkyl” refers to an alkyl group substituted by, for example, 1-25 substituents, and most preferably 1-4 substituents. Substituents may include, without limitation, hydroxy, alkoxy, halo, cycloalkoxy, oxo, amino, monoalkylamino, dialkylamino, aryl and substituted aryl. Among the alkyl substituents noted above, particularly preferred are hydroxy substituents.

The term “lower alkenyl” refers to straight- or branched-chain, unsubstituted, unsaturated hydrocarbon groups of 1-6 carbon atoms. Examples of lower alkenyl groups include ethenyl, propenyl, butenyl, pentenyl and the like.

The term “substituted alkenyl” refers to an alkenyl group substituted by, for example, 1-12 substituents, and most preferably, 1-4 substituents. The substituents are the same as those described above with reference to the alkyl groups.

The term “aryl” refers to monocyclic or polycyclic aromatic hydrocarbon groups having 6-15 carbon atoms in the ring portion, such as phenyl, naphthyl, biphenyl, indenyl, fluorenyl or the like, each of which may be substituted.

The term “substituted aryl” refers to an aryl group, as defined above, substituted by, for example, 1-7 substituents, and preferably, 1-4 substituents, such as those described above with reference to the substituted alkyl and alkenyl groups.

The term “halogen” refers to fluorine, chlorine, bromine or iodine.

When a moiety is described herein as substituted with more than one substituent, it is intended that each of the multiple substituents be chosen independently from among the substituents mentioned above.

Compounds encompassed by Formula I, above, have asymmetric carbon atoms, and therefore, can exist as paired enantiomers, differing in their optical activity. The compounds may be used in enantiomerically pure form, in racemic form or in other mixed forms.

Preferred compounds for use in the practice of this invention include: menthol propyleneglycol-carbonate, isopulegol propyleneglycol-carbonate, menthyl-9-hydroxynonyl-carbonate, menthoxy-propane-1,2-diol, and N-ethyl-p-menthane-3-carboxamide.

The menthol propyleneglycol-carbonate and analogs described herein have been shown to be effective repellents of a wide range of insect pests that are harmful to man, either directly as disease vectors, or indirectly as destroyers of crops, food products, or textile fabrics. As exemplified hereinbelow, remarkable repellent effects have been achieved with respect to flying insects, such as mosquitoes and house flies, crawling insects, such as ants and boring insects, such as termites. The testing carried out to date indicates that compounds of Formula I, above, will also be effective as repellents against the following insects: aphids, beetles, bees, borers, bugs, caspids, caterpillars, cockroaches, fleas, flea hoppers, fruit flies, grass hoppers, leaf hoppers, leaf miners, mealy bugs, miners, mites, moths, scales, spiders, slugs, ticks, thrips, wasps, weevils, white flies and yellow jackets. Specific examples of insect species against which the compounds described herein may be used as repellents include the following:

Aphids:

Acyrthosiphon pisum, Aphis fabae, bean aphid, Aphis glycines, Soybean aphid, Aphis gossypii, melon aphid, Aphis middletonii, erigeron root aphid, Aphis nerii, oleander aphid, Aphis spiraecola, spirea aphid, Aulacorthum circumflexum, crescentmarked lily aphid, Bemisia tabaci, sweetpotato whitefly, Brachycolus heraclei, celery aphid, Brevicoryne brassicae, cabbage aphid, Cavariella aegopodii, an aphid, Cerataphis orchidearum, fringed orchid aphid, Dysaphis apiifolia, rusty-banded aphid, Hyperomyza lactucae, an aphid, Lipaphis erysimi, turnip aphid, Macrosiphum euphorbiae, potato aphid, Macrosiphum luteum, orchid aphid, Melanaphis sacchari, sugarcane aphid, Myzus ornatus, ornate aphid, Myzus persicae, green peach aphid, Neomyzus circumflexum, crescentmarked lily aphid, Neotoxoptera formosana, onion aphid, Patchiella reaumuri, taro root aphid, Pentalonia nigronervosa, banana aphid, Rhopalosiphum maidis, corn leaf aphid, Rhopalosiphum nymphaea, waterlily aphid, Rhopalosiphum rufiabdominalis, rice root aphid, Toxoptera aurantii, black citrus aphid, Toxoptera citricida, brown citrus aphid, Vesiculaphis caricis, an aphid,

Ants:

Anoplolepis longipes, longlegged ant, Pheidole megacephala, bigheaded ant, Formica spp., field ants, Lasius spp., Cornfield ants, amponotus spp., carpenter ants, Pogomomyrmex spp., harvester ants, Tetramorium caesptium, pavement ants, Monomorium pharoanis, pharaoh ants, Solenopsis molesta, thief ants, Linepithema humile, Argentine ants, Solemopsis spp. Fire ants, Tapinoma melanocephalum, Ghost ants, Crematogaster spp., Crematogaster ants, Paratrechina longicornis, crazy ants Anoplolepis gracilipes, yellow crazy ants,

Beetles:

Adoretus sinicus, Chinese rose beetle, Anthonomus eugenii, pepper weevil, Anthrenus sp., Carpet beetles, Apomecyna saltator, cucurbit longicorn, Asynonychus godmani, Fuller rose beetle, Attagenus Mezatoma, Black carpet beetle, Carpophilus hemipterus, driedfruit beetle, Carpophilus humeralis, yellowshouldered souring beetle, Chaetocnema confinis, sweetpotato flea beetle, Coleoptera, a beetle, Cosmopolites sordidus, banana root borer, Cryptorhynchus mangiferae, mango weevil, Cylas formicarius elegantulus, sweetpotato weevil, Elytroteinus subtruncatus, Fijiian ginger weevil, Epitrix hirtipennis, tobacco flea beetle, Euscepes postfasciatus, West Indian sweetpotato weevil, Harmonia axyridis, Multicolored Asian Lady Beetle, Hypothenemus obscurus, tropical nut borer, Lasioderna serricorne, Cigarette beetle, Lema trilinea, threelined potato beetle, Listroderes difficilis, vegetable weevil, Maruca testulalis, bean pod borer, Omphisa anastomosalis, sweetpotato vine borer, Orchidophilus aterrimus, orchid weevil, Orchidophilus peregrinator, lesser orchid weevil, Oryzaephilus mercator, merchant grain beetle, otiorhynchus cribricollis, cribate weevil, Popillia japonica, Japanese Beetle, Protaetia fusca, mango flower beetle, Stegobium paniceum, Drugstore beetle, Tribolium castaneum, red flour beetle, Tribolium confusum, confused flour beetle, Xyleborus affinis, a scolytid beetle, Xyleborus crassiusculus, a scolytid beetle, Xyleborus fornicatus, a scolytid beetle, Xylosandrus compactus, black twig borer,

Bees:

Apis mellifera, Africanized or European honey bee, Xylocopa sp., Carpenter bees,

Borers:

Maruca testulalis, bean pod borer, Ostrinia nubilalis, European corn borer,

Bugs:

Antianthe expansa, solanaceous treehopper, Coptosoma xanthogramma, black stink bug, Cyrtopeltis modestus, tomato bug, Draeculacephala minerva, grass sharpshooter, Empoasca stevensi, Stevens leafhopper, Gnorimosphaeroma sp., pillbugs Hyalopeplus pellucidus, transparentwinged plant bug, Hemiptera, a bug, Lamenia caliginea, a fulgorid planthopper, Lepismatidae spp., Silverfish, Leptocoris trivittatus, Eastern Box bug, Leucopoecila albofasciata, a fleahopper, Melormenis basalis, West Indian flatid, Nabis capsiformis, pale damsel bug, Nezara viridula, southern green stink bug, Nysius nemorivagus, a lygaeid bug, Nysius nigriscutellatus, a lygaeid bug, Plautia stali, oriental stink bug, Pycnoderes quadrimaculatus, bean caspid, Siphanta acuta, torpedo bug, Spanagonicus albofasciatus, whitemarked fleahopper, Spissistilus festinus, threecornered alfalfa hopper, Tarophagus colocasiae, taro delphacid, Vanduzeea segmentata, Van Duzee treehopper,

Caspids:

Pycnoderes quadrimaculatus, bean caspid,

Caterpillars:

Achaea janata, croton caterpillar, Acrolepia assectella, leek moth, Agrius cingulatas, sweetpotato hornworm, Agrotis ipsilon, black cutworm, Amorbia emigratella, Mexican leafroller, Anacamptodes fragilaria, koa haole looper, Anua indiscriminata, guava moth, Cadra cautella, almond moth, Chrysodeixis eriosoma, green garden looper, Conoderus amplicollis, Gulf wireworm, Cryptoblabes gnidiella, Christmas berry webworm, Cryptophlebia illepida, koa seedworm, Cryptophlebia ombrodelta, litchi fruit moth, Daphnis nerii, oleander hawk moth, Delia platura, seedcorn maggot, Empoasca solana, southern garden leafhopper, Hedylepta blackburni, coconut leafroller, Helicoverpa zea, corn earworm, Hellula undalis, imported cabbage webworm, Keiferia lycopersicella, tomato pinworm, Lampides boeticus, bean butterfly, Othreis fullonia, Pacific fruit-piercing moth, Pelopidas thrax, banana skipper, Penicellaria jocosatrix, mango shoot caterpillar, Peridroma saucia, variegated cutworm, Phthorimaea operculella, potato tuberworm, Pieris rapae, imported cabbageworm, Plutella xylostella, diamondback moth, Spodoptera exempta, nutgrass armyworm, Spodoptera exigua, beet armyworm, Spoladea recurvalis, Hawaiian beet webworm, Strymon echion, larger lantana butterfly, Trichoplusia ni, cabbage looper, Vanessa cardul, painted lady butterfly,

Cockroaches:

Blaberus craniifer, deaths-head cockroach, Blaberus discoidalis, discoid cockroach, Blatta orientalis, oriental cockroach, Byrsotria fumigata, Cuban burrowing cockroach, Diploptera punctata, beetle roach, Eublaberus posticus, Cave dwelling cockroach, Gromphadorhina portentosa, hissing cockroach, Leucophaea maderae, Madeira cockroach, Periplaneta americana, common American cockroach, Periplaneta brunea, brown cockroach, Periplaneta fulginosa, dusky brown cockroach, Schultesia lampyridiformis, firefly roach, Supella longipalpa, brown banded cockroach,

Fleas:

Ctenocephalides felis (Bouche), cat flea, Siphonaptera, a flea,

Fleahoppers:

Leucopoecila albofasciata, a fleahopper, Spanagonicus albofasciatus, whitemarked fleahopper,

Plies:

Asilidae sp., robber flies, Bactrocera cucurbitae, melon fly, Ceratopogonidae sp., Chironomidae sp., Conoderus amplicollis, Gulf wireworm, Contarinia maculipennis, blossom midge, Culicidae sp. Dasineura mangiferae, mango blossom midge, Delia echinata, carnation tip maggot, Delia platura, seedcorn maggot, Eumerus figurans, ginger maggot, Eurychoromyiidae sp. Broad headed flies, Milichiidae sp. Small flies, Mydidae sp. True flies, Musca domestica, house fly, Ophiomyia phaseoli, bean fly, Phoridae sp., Sciaridae sp., Simuliidae sp. Black flies, Syrphidae sp. Flower flies, Tachinidae sp. Parasitic flies, Tanyderidae sp. Primitive crane flies, Therevidae sp. Stiletto flies,

Fruitflies:

Bactrocera cucurbitae, melon fly, Bactrocera dorsalis, oriental fruit fly, Bactrocera latifrons, solanaceous fruit fly, Ceratitis capitata, Mediterranean fruit fly, Drosophilidae sp. Fruit fly, Tephritidae sp. Fruit flies,

Grasshoppers:

Atractomorpha sinensis, pinkwinged grasshopper, Conocephalus saltator, longhorned grasshopper, Elimaea punctifera, narrowwinged katydid,

Leafhoppers:

Empoasca solana, southern garden leafhopper, Empoasca stevensi, Stevens leafhopper, Sophonia rufofascia, two-spotted leafhopper,

Leafminers:

Acrolepiopsis sapporensis, Asiatic onion leafminer, Bedellia orchilella, sweetpotato leafminer, Liriomyza brassicae, serpentine leafminer, Liriomyza huidobrensis, pea leafminer, Liriomyza sativae, vegetable leafminer, Liriomyza trifolii, chrysanthemum leafminer, Pjyllocinistis citrella, Citrus Leafminer

Mealybugs:

Antonina graminis, Rhodesgrass mealybug, Dysmicoccus brevipes, pineapple mealybug, Dysmicoccus neobrevipes, gray pineapple mealybug, Ferrisia virgata, striped mealybug, Geococcus coffeae, coffee root mealybug, Nipaecoccus nipae, coconut mealybug, Nipaecoccus viridis, hibiscus mealybug, Phenacoccus gossypii, Mexican mealybug, Planococcus citri, citrus mealybug, Pseudococcus dendrobiorum, dendrobium mealybug, Pseudococcus jackbeardsleyi, Jack Beardsley mealybug, Pseudococcus longispinus, longtailed mealybug, Pseudococcus virburni, obscure mealybug,

Miners:

Melanagromyza splendida, safflower stemminer,

Mites:

Aculops lycopersici, tomato russet mite, Brevipalpus obovatus, privet mite, Brevipalpus phoenicis, red and black flat mite, Calacarus brionesae, papaya leaf edgeroller, Eotetranychus sexmaculatus, sixspotted mite, Eriophyes mangiferae, mango bud mite, Eutetranychus banksi, Texas citrus mite, Oligonychus mangiferus, mango spider mite, Panonychus citri, citrus red mite, Polyphagotarsonemus latus, broad mite, Siteroptes framinum, grass mite, Steneotarsonemus furcatus, taro tarsonemid mite, Steneotarsonemus pallidus, cyclamen mite, Tetranychus cinnabarinus, carmine spider mite, Tetranychus desertorum, desert spider mite, Tetranychus neocalidonicus, vegetable mite, Tetranychus tumidus, tumid spider mite, Tuckerella ornata, Tuckerellid mite, Tuckerella pavoniformis, Tuckerellid mite, Varroa jacobsoni, Varroa mite,

Moths:

Actias luna, Luna moth, Anisota sp., Oakworm moths, Antheraea polyphemus, Polyphemus moth, Automeris io, Io moth, Callosamia sp., silk moth, Eacles imperialis, Imperial moth, Hemileuca maia, eastern buckmoth, Hyalophora cecropia, silk moth, Plodia interpunctella, Indian Meal Moth, Plutella xylostella, Diamondback moth, Sphingicampa sp., Honey locust moths, Tineola bisselliella, clothing moth, Trichophaga tapetzella, carpet or tapestry moth,

Mosquitoes:

Aedes sp, Anopheles sp., Coquilltettidia sp., Culex sp., Culiseta sp., Ochlerotatus sp., Psorophora sp.,

Scales:

Abgrallaspis cyanophylli, an armored scale, Aspidiella hartii, a turmeric root scale, Aspidiotus destructor, coconut scale, Aspidiotus nerii, oleander scale, Asterolecanium pustulans, oleander pit scale, Ceroplastes rubens, red wax scale, Chrysomphalus aonidum, Florida red scale, Chrysomphalus dictyospermi, dictyospermum scale, Clavaspis herculeana, an armored scale, Coccus hesperidum, brown soft scale, Coccus longulus, long brown scale, Coccus viridis, green scale, Diaspis boisduvalii, Boisduval scale, Diaspis bromeliae, pineapple scale, Duplaspidiotus claviger, an armored scale, Fiorinia fioriniae, avocado scale, Furcaspis biformis, red orchid scale, Hemiberlesia lataniae, latania scale, Hemiberlesia rapax, Greedy scale, Howardia biclavis, mining scale, Icerya purchasi, cottony-cushion scale, Ischnaspis longirostris, black thread scale, Kilifia acuminata, acuminate scale, Melanaspis bromeliae, brown pineapple scale, Morganella conspicua, an armored scale, Parasaissetia nigra, nigra scale, Parlatoria proteus, variable chaff scale, Pinnaspis aspidistrae, fern scale, Pinnaspis buxi, ti scale, Pinnaspis strachani, Hibiscus snow scale, Protopulvinaria mangiferae, mango soft scale, Pseudaulacaspis cockerelli, Cockerell scale, Pulvinaria mammeae, large cottony scale, Pulvinaria psidii, green shield scale, Pulvinaria urbicola, cottony sweetpotato scale, Saissetia coffeae, hemispherical scale, Saissetia neglecta, Caribbean black scale, Vinsonia stellifera, stellate scale,

Spiders:

Araneidae sp., Orb web spiders, Atrax sp., Funnel web spiders, Loxosceles sp., Recluse spiders, or violin spiders, Lycosidae sp., Wolf spiders, Pholcidae sp., Cellar spiders, Salticidae sp., Jumping spiders, Tegenaria agrestis, Hobo or Aggressive house spiders,

Slugs:

Vaginulus plebius, brown slug, Veronicella leydigi, black slug,

Ticks:

Amblyomma americanum, Lone Star Tick, Dermacentor variabilis, American Dog Tick, Ixodes scapularis, Deer Tick, Rhipicephalus sanguineus, Brown dog tick,

Thrips:

Chaetanaphothrips orchidii, anthurium thrips, Chaetanaphothrips signipennis, banana rust thrips, Dichromothrips corbetti, vanda thrips, Echinothrips americanus, a thrips, Elixothrips brevisetis, banana rind thrips, Frankliniella occidentalis, western flower thrips, Frankliniella shultzei, yellow flower thrips, Haplothrips gowdeyi, black flower thrips, Helionothrips errans, cymbidium thrips, Heliothrips haemorrhoidalis, greenhouse thrips, Hercinothrips feinoralis, banded greenhouse thrips, Leucothrips pierci, a thrips, Schultzei, yellow flower thrips, Sciothrips cardamomi, cardamom thrips, Scirtothrips dorsalis, a thrips, Selenothrips rubrocinctus, redbanded thrips, Thrips alliorum, a thrips, Thrips hawaiiensis, Hawaiian flower thrips, Thrips nigropilosus, chrysanthemum thrips, Thrips palmi, melon thrips, Thrips tabaci, onion thrips,

Wasps:

Bephratelloides cubensis, Annona seed wasp, Eurytoma orchidearum, orchidfly, Polistes sp., Paper wasps, Sphecidae sp., Mud Dauber wasps,

Weevils:

Anthonomus eugenii, pepper weevil, Diaprepes abbreviatus, Citrus root weevil,

Whiteflies:

Aleurocanthus spiniferus, orange spiny whitefly, Aleurodicus dispersus, spiraling whitefly, Aleurothrix antidesmae, a white fly, Aleurothrixus floccosus, woolly whitefly, Aleurotulus anthuricola, anthurium whitefly, Bemisia argentifolii, silverleaf whitefly, Bemisia tabaci, sweetpotato whitefly, Crenidorsum sp., a whitefly, Orchamoplatus mammaeferus, croton whitefly, Paraleyrodes perseae, plumeria whitefly, Trialeurodes vaporariorum, greenhouse whitefly,

Yellowjackets:

Vespula vulgaris, common yellowjacket, Vespula maculifrons, eastern yellowjacket, Vespula germanica, german yellowjacket, Vespa crabro, giant hornet

In carrying out the methods of the invention, the compounds of Formula I may be used neat, or as a component of a composition obtained by admixture with a suitable carrier or vehicle. The nature of the carrier or vehicle will vary depending on the mode of application or administration.

The insect repellent compositions of the invention are formulated to include an effective amount of a compound of Formula I which is generally from about 1 to about 80 wt %, based on the total weight of the composition. It has been found that compositions in which a compound of Formula I is present in an amount of less than 1 wt % does not produce the intended effect. The composition may optionally include from about 3 to about 80 wt % of a skin conditioner, with the balance being one or more inactive ingredients that constitute the carrier or vehicle. Particularly satisfactory insect repellent effects have been obtained using formulations containing from about 1 to about 30 wt % of a compound of Formula I above, preferably a racemic mixture of menthol propyieneglycol-carbonate. Isopulegol propyleneglyol-carbonate also produced good results. These compounds can be safely applied to the integument or skin of humans, livestock, pets, plants, plant parts and seeds.

The insect repellent effect produced by the compounds described herein may also be incorporated in various cosmetics or personal care products, including, without limitation, perfumes, colognes, deodorants, anti-perspirants, skin creams, soaps, shampoos, hair conditioners, hair rinses, bath oils, talcs, sunblocks, sunscreens and the like; or in household cleaning products including, without limitation, cleansers, detergents, fabric softeners, air fresheners, upholstery or rug shampoos, furniture polishes, floor waxes or the like, which products may be in either liquid or solid form. These products will typically contain from about 1 to about 80 wt % of a compound or mixture of compounds of Formula I above, based on the tare weight of the product. The insect repellent compounds may also be mixed with fertilizer, mulch and potting preparations.

The compounds of Formula I can be used as the sole insect repellent in a composition or may be used in combination with other natural or synthetic agents that are effective insect repellents. These include, without limitation, N,N-diethyl-m-toluamide(DEET); N,N-diethylbenzamide; citronella; Tolu balsam; Peru balsam; eucalyptus oil; Huon pine oil; camphor; cypress oil; galbanum; diethylphthalate; dimethylphathalate; dibutylphthalate; 1,2,3a,4,5,5a,6,7,8,9,9a,9b-dodecahydro-3a,6,9a-tetramethylnaphtho[2,1-b]furan; 4-(tricyclo[5.2.1.0^{2,6}]decylidene-8)butanal; 1-ethoxy-1(2′-phenylethoxy)ethane; acetyl cedrene and propylidene phthalide.

Various auxiliary ingredients may be added to the above-described compositions to impart desired properties or characteristics thereto or to facilitate application or administration in a particular way. These auxiliary ingredients may include, without limitation, fragrances, surfactants, propellants, emulsifiers, dispersants, buffers, preservatives, antioxidants, diluents, solvents and fixatives, as is common practice in the art.

The deleterious activity of microorganisms may be inhibited by the inclusion of various antibacterial and antifungal agents, e.g., paraben, chlorobutanol, phenol, sorbic acid and the like.

The compositions described above may be prepared in various forms depending on the mode of application or administration. Thus, compositions may be in the form of a lotion, cream, ointment, gel or powder for topical application or a solution or suspension for use as an atomized or aerosol spray.

The compounds and compositions described herein may be formulated with sustained or controlled release components or carriers of various types, e.g. organic or inorganic particulates, or in alcohol or water-based formulations for topical use, as is well known in the art.

Compositions used in practicing the invention can be prepared by various methods well known in the art. Typically, such compositions are prepared by intimately mixing a compound of Formula I with a suitable carrier material and optionally one or more auxiliary ingredients, as desired, and putting the resulting mixture into a suitable container or dispenser.

The compounds and compositions described herein are beneficially applied to animals and plants, as well as inanimate objects to produce the desired insect repellent effect. In most cases, the insect repellent composition of the invention will be topically or externally applied to the site or surface to be treated, and the application will be periodically repeated to maintain the desired level of insect repellent.

The compounds described herein may also be used beneficially in various coating compositions, such as architectural and industrial coating products, in order to inhibit insect infestation by repelling insects from the treated surfaces. Such coating compositions are conveniently formulated by mixing one or more of the compounds of Formula I, above, with a conventional paint vehicle, including a suitable film-former, which is readily applied and adheres to the site or surface that is to be protected against insect infestation. The coating composition may be applied in various ways, including, for example, brushing, spraying or dipping.

The specific film-former to be selected for a particular application will vary depending on the material and construction of the article to be protected. After a surface is provided with a protective coating in accordance with this invention, the active ingredient of Formula I which is present in the coating composition provides its insect repellent effect, thereby protecting the treated surface against infestation. A variety of synthetic polymers are known to be useful film-formers for coating applications. Examples of suitable polymer resins include polyester (e.g. alkyd) resins, unsaturated polymer (e.g. acrylic) resins, vinyl ester, vinyl acetate and vinyl chloride-based resins, urethane-based resins, epoxy resins and silicone resins or combinations thereof. Unsaturated polyester resins are formed from unsaturated acids and anhydrides, saturated acids and anhydrides (to control the amount of unsaturation in the final resin) and polyhydroxy alcohols, usually glycols. Preferred film former components are polyurethane, epoxy, alkyd and silicone resins. Commercial paint vehicles which are suitable for the practice of this invention include the following: Benwood Interior Wood Finishing penetrating stain 234 and Benwood Interior Wood Finishing polyurethane stain 228 (both from Benjamin Moore Paints); Van Sickle Exterior latex paints (Van Sickle Paints, Lincoln, Nebr.); Polane G Plus polyurethane enamel and ACRI-PRO 100 flat exterior acrylic paint (both from Porter Paints, Louisville, Ky.); and Wearlon non-stick coatings (water based silicone/epoxy coatings) (Environmental Coatings, LLC).

The coating composition of the invention may include components in addition to a compound or compounds of Formula I above, and a film former component, so as to confer one or more desirable properties, such as color, hardness, strength, rigidity, permeability, water resistance or the like. The selection of a particular component or group of components to impart such properties are within the capabilities of those having ordinary skill in the art.

The percentage of the repellent compound in the coating composition required for effective protection against insect infestation may vary depending on the compound itself, the chemical nature of the film former, as well as other additives present in the composition that may influence the effectiveness of the repellent compound. Generally, the repellent compound comprises between about 1 and about 80% of the coating composition by weight, and preferably between about 5 and about 50% by weight of the composition.

The compounds of Formula I, above, may be included in a paint formulation during the paint manufacturing process, or added to the paint at the time of use. The compounds of Formula I may be simply mixed into the paint vehicle. The repellent compound may also be covalently bound to the polymer resin. Furthermore, the compounds of Formula I may be incorporated with time-release materials, which provide sustained release of the compounds from the coating matrix, thereby prolonging the effectiveness of the coating and reducing the amount of active compound necessary to produce the insect repellent effect. Encapsulation into such time-release materials also protects the active ingredient from the harsh chemical environment of the coating, and tends to reduce degradation of the active compounds while trapped in the resin if they are susceptible to degradation. Examples of suitable controlled release materials include: liposomes, nanocapsules, lipid microtubules, metal micro-tubules, polymers and halloysite microtubules.

Insect repellent effects on coated surfaces are obtainable using compounds of Formula I, above, at a surface concentration of from about 1 to about 600 mg/cm², more preferably from about 10 to about 80 mg/cm², and most preferably from about 30 to about 50 mg/cm². Relatively higher concentrations, on the order of from about 300 to about 600 mg/cm² will be used to repel mosquitoes

Also within the scope of this invention is any structure or article having a surface coating with a coating composed of at least one compound of Formula I, above. The coated structure or article can comprise any material which insect pests are likely to attack, such as live trees, agricultural plants, ornamental plants, seeds, wood or lumber, furniture, flooring and walls.

The compounds described herein may also be incorporated into a fabric substrate to render the fabric insect repellent. The repellent compound(s) may be combined with various synthetic fibers during the fiber manufacturing process, e.g. by dry spinning. Fibers which may be made in this manner include, without limitation, polyester, polyamide (preferably nylon), acrylics and polyolefins (preferably polyethylene) fibers. The fibers or filaments thus obtained are spun into yarn which is then woven or knitted into the finished insect repellent fabric. Of course, knitted fabric may also be made from single filaments. The resulting fiber may also be used to produce non-woven fabrics.

The repellent compound(s) may also be associated with finely divided carriers, having particle sizes in the micrometer to nanometer range, for inclusion in the cladding or core of spun fibers. The particular carrier can be appropriately selected to protect the repellent compound from adverse thermal effects, e.g. in melt spinning procedures. Suitable particulate carriers for this purpose include, without limitation, polymeric capsules, halloysite microtubules and metal microtubules. Carriers such as halloysite microtubules also enable controlled release of the insect repellent from the resultant fibers. See also U.S. Pat. No. 6,326,015, which relates to slow-release insect repellent fabric.

Alternatively, the insect repellent may be applied to the finished fabric, e.g. by spraying, impregnation, padding (by means of an immersion tank and squeeze roller) or the like.

The insect repellent fabric can be converted into a wide variety of useful articles including, without limitation, garments such as Battle Dress Uniforms used by the military, tent fabric, mosquito netting, bandannas, animal bedding materials or protective wraps for trees and other plants. The insect repellent compound(s) may also be applied to the fabric after it is made into a finished article. Cotton cloth or netting may also be rendered insect repellent in accordance with this invention.

The insect repellent compounds described herein are preferably used for rendering mosquito netting insect repellent. A practical procedure for treating mosquito netting with insecticide is described at www.pathcanada.org, the details of which are incorporated by reference herein.

Barrier sheets effective for protecting wooden structures from termites and other boreing insects may also include one or more insect repellent compounds of Formula I, above. Such barrier sheets may be prepared in the form of polymer films, which may be manufactured by convention molding, casting or extruding methods, depending on the nature of the polymer used. Incorporation of the insect repellent compound(s) into the polymer film may be carried out in a manner similar to that described above for synthetic polymer fibers, including controlled-release embodiments. The insect repellent may also be applied to a film substrate by means of a physical melt-bonded mixture of compatible polymer and repellent, which is bonded in spaced apart spots to the film substrate, in the manner described in U.S. Pat. No. 6,319,511.

Insect repellent-containing fibers, prepared as described above, may also be used to form a protective barrier for control of agricultural pests, as described in U.S. Pat. No. 6,052,943.

The following examples set forth further details regarding the invention. These examples are provided for illustrative purposes only, and are not intended to limit the invention in any way. These examples show the results of tests conducted to determine the efficacy of certain compounds of Formula I, above, as insect repellents.

Examples 1 through 9 show the insect repellent effect of compounds of Formula I, above.

### EXAMPLE 1

Adult mosquitoes (Culex quinquefasciatus) were kept inside a screened chamber measuring 2 ft×2 ft×2 ft at a density of 200 mosquitoes per chamber. The mosquitoes are aged 3 to 10 days after emergence from larvae and were starved for 24 hours prior to each test. Each of the test compounds (supplied as a gift from Symrise GmbH & Co Kg, Holzminden, Germany) was added to a commercial lotion base (Cresto Laboratories, Manila, Philippines) and thoroughly mixed into the lotion using an electronic mixer. The resulting formulation was applied from the elbow to the tip of the fingers of human volunteers. The coated arms of the volunteers were then inserted, in turn, inside the chamber up to the elbow. The protection time was determined for each formulation as the length of time until a mosquito had taken its first bite, after which the test was terminated. The data in Table 1 show the protection time determined in this manner for the compounds tested.

TABLE I

| | Protection Time |
|---|---|
| Chemical Name (Synonym) | (minutes)* |
| 1-5-methyl-2-isopropyl cyclohexanol (1-menthol) | 30 ± 9 |
| 5-methyl-2-(1-methylethenyl) | 56 ± 7 |
| cyclohexanol ((−)-isopulegol) | |
| menthoxy-propane-1,2-diol | 68 ± 17 |
| N-Ethyl-p-menthane-3-carboxyamide | 92 ± 31 |
| menthol propyleneglycol-carbonate | 68 ± 15 |
| racemic menthol propyleneglycol-carbonate | 283 ± 17 |
| isopulegol propyleneglycol-carbonate | 152 ± 36 |
| menthyl-9-hydroxynonyl-carbonate | 79 ± 14 |

*Mean ± Standard error of the mean for 4 volunteers per test group. Compounds were added to the lotion base at a concentration of 5 wt %, based on the total weight of the composition.

The data show that the racemic form of menthol propyleneglycol-carbonate is almost nine times more effective than menthol or isopulegol in preventing mosquito bites. The performance of menthol propyleneglycol-carbonate will vary depending upon the cosmetic formulation used for the tests.

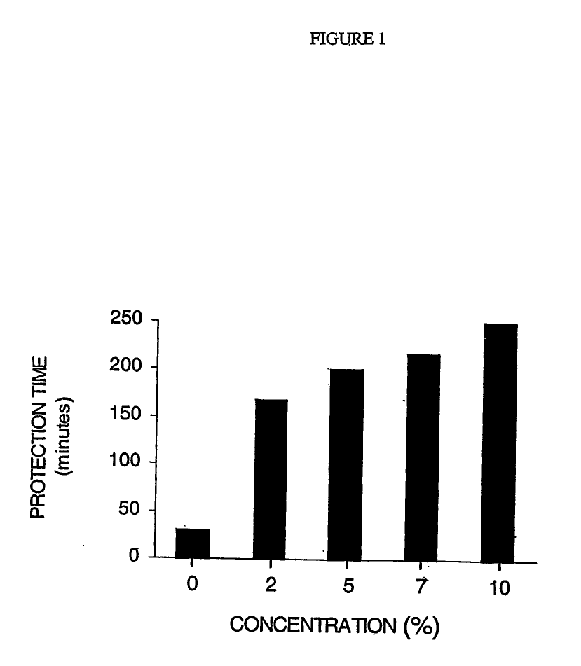

Further experiments demonstrated that the inhibitory effect of racemic menthol propyleneglycol-carbonate on mosquito bite occurs in a dose dependent manner. The results of these experiments are shown in FIG. 1.

### EXAMPLE 2

The red ant (pharaoh ant, Monomorium pharaonis) was selected for this ant repellent test since it has a worldwide distribution and is known to be a household pest.

Red ants are attracted to the smell of food. The attractant in this experiment was a piece of chocolate, which was placed on a tabletop 5 hours before the test. Within 2 hours after being released on the ground around the table, the red ants established a route from the ground up the table legs. At the 5th hour, a filter paper impregnated with racemic menthol propyleneglycol-carbonate at two concentrations was placed around the middle portion of the table leg. The test compound was dissolved in ethanol and impregnated into a pre-weighed, 2 inch by 7 inch piece of filter paper. After complete evaporation of ethanol, the filter paper was weighed and the final weight of the test compound was determined per cm² of the filter paper. The control employed was the same filter paper soaked with ethanol only. The time for the first ant to cross the filter paper barrier was determined.

The data are shown in Table II. The results show that racemic menthol propyleneglycol-carbonate, at appropriate concentration, is an effective repellent against red ants.

TABLE II

| | Concentration | Time to cross barrier * |
|---|---|---|
| TEST GROUP | (mg/cm²) | (Minutes) |
| CONTROL | 0 | <1 |
| Racemic menthol | 15 | 63 ± 18 |
| propyleneglycol-carbonate | | |
| Racemic Menthol | 30 | 760 ± 76 |
| propyleneglycol-carbonate | | |

Each data point is the mean ± SEM of 5 tests.

### EXAMPLE 3

Common houseflies, Musca domestica, were collected using butterfly nets and placed inside a net cage measuring 1 cubic foot. The houseflies were acclimatized in the new environment for 3 hours prior to the test. A standard slice of raw beef was placed in the middle of the cage to attract the houseflies. Racemic menthol propylene glycol-carbonate was added to 95% ethanol at concentrations ranging from 10% to 50% v/v. These experimental solutions were uniformly sprayed with a spray bottle on the surface of the beef. Control tests utilized the 95% ethanol solution without any of the test compound and sprayed on the surface of the beef in the same manner. Protection time refers to the time at which the first housefly landed on the surface of the raw beef.

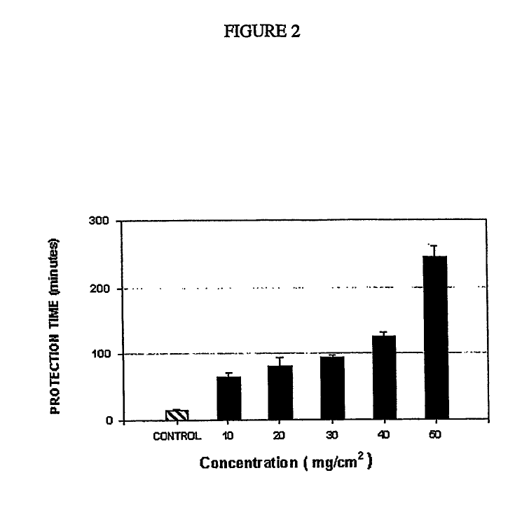

The data obtained during the above-described tests appears in FIG. 2, which shows a dose-related inhibition of housefly landing on the surface of the raw beef, indicating that menthol propylene glycol carbonate was effective in protecting treated surfaces against housefly infestation.

### EXAMPLE 4

Effect of Combining Menthol Propyleneglycol-Carbonate with DEET and Citronella

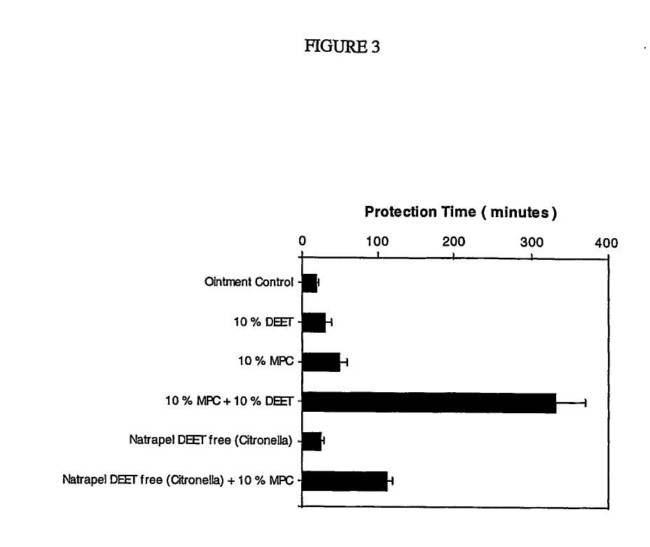

To test the effectiveness of menthol propyleneglycol-carbonate(menthol propyleneglycol-carbonate) in enhancing the effect of the known insect repellent DEET against mosquito biting activity, this study was undertaken by combining racemic menthol propyleneglycol-carbonate with DEET (purchased from Sigma-Aldrich). The two chemicals were added at 10% w/w in an Hydrophilic ointment base (E. Fougera & Co., Melville, N.Y.) and applied on the exposed arms of human volunteers. The treated arms were inserted inside a mosquito chamber and the protection time was determined. The data obtained during this study appears in FIG. 3, which shows that the addition of 10% racemic menthol propyleneglycol carbonate in an ointment base with DEET resulted in a greater protection time, as compared with either of the two active compounds alone. The recorded data represents the mean and standard error of 3 human volunteers.

To test the effectiveness of menthol propyleneglycol-carbonate in enhancing the effect of another known mosquito repellent product, an experiment was undertaken in Which menthol propyleneglycol-carbonate was added at a concentration of 10% w/w to a citronella-based product (Natrapel) manufactured by Tender Corporation (Littleton, N.H.). Citronella oil is a malodorous natural extract from the leaves of the plant, Cymbopogon nardus, with insect repellent activity. menthol propyleneglycol-carbonate increased the protection time of Natrapel from 23 minutes to 108 minutes, thereby demonstrating that this chemical can be used to augment the effect of weaker acting formulated products, such as those containing citronella oil.

### EXAMPLE 5

Outdoor Mosquito Tests

To validate the efficacy of menthol propyleneglycol-carbonate under ambient conditions in nature, this chemical was mixed in an ointment base at 10% w/w and applied to the exposed arms of human volunteers who remained outdoors during the peak period of mosquito biting, beginning at 3:00 PM. The protection time was recorded and compared with that obtained from human volunteers using a commercially available insect repellent (OFF! Skintastic; 7% DEET) manufactured by SC Johnson & Sons, Inc. (Racine, Wis.). Control ointment consisted of Fougera ointment without any active ingredient. The protection time was determined for 3 human volunteers for each test group.

Table III below shows that the efficacy of 10% racemic menthol propyleneglycol-carbonate is somewhat better than that of OFF! Skintastic, thereby demonstrating that the effects seen in the laboratory can be duplicated under natural conditions.

TABLE III

| | PROTECTION TIME |
|---|---|
| STUDY GROUP | (minutes ± SEM) |
| CONTROL | 10 ± 3 |
| OFF! SKINTASTIC | 194 ± 4 |
| 10% Racemic menthol propyleneglycol carbonate | 227 ± 19 |

### EXAMPLE 6

Inhibition of Termite Infestation

The milk termite, Coptotermes vastator, is a pest found in tropical and sub-tropical areas. To test the efficacy of racemic menthol propyleneglycol-carbonate, this chemical was dissolved in 95% ethanol at concentration of 10% w/w and pieces of pre-weighed soft wood were immersed in the solution for 24 hours. After impregnation, the wood was allowed to dry in air to remove the ethanol which has a lower flash point. The dry wood was reweighed to determine the total amount of racemic menthol propyleneglycol-carbonate absorbed into the wood. The weight of racemic menthol propyleneglycol-carbonate absorbed was 26 milligrams per gram of wood. Controls were prepared using wood impregnated with 95% ethanol alone.

The wood test samples were placed on top of a fallen jackfruit tree (Artocarpus heterophylla) heavily infested by termites under ambient, natural, outdoor conditions for a period of 2 months. At the end of the test period, the wood samples were cleaned of debris and termites, dried in the sun and weighed. The degree of wood preservation was determined by the amount of weight loss during the test period.

TABLE IV

| Treatment Group | Percent of weight loss |
|---|---|
| CONTROL | 26.6 ± 7.1 |
| Racemic menthol propyleneglycol carbonate | 0.8 ± 0.4 |

The data in Table IV show that termites were able to destroy the wood in the control group within the period of the study. When periodically checked visually, termites were seen within the wood samples in the control group. However, when racemic menthol propyleneglycol-carbonate was impregnated into the wood, the termites were completely prevented from consuming the wood, as evidenced by the minimal weight loss of the experimental wood samples.

### EXAMPLE 7

Effect of Menthol Propyleneglycol-Carbonate Against Fire Ants

Fire ants are bothersome pests in the southern United States. The tropical fire ant (Solenopsis geminata Fabricius) is native to the United States. However, the more aggressive imported species of the red ants (S. invicta) is dominating the southern part of the United States because of its aggressiveness. Fire ants are known to damage 57 species of cultivated plants. They feed on germinating seeds as well as other insects. Because of attraction to electrical currents, they also cause considerable damage to heat pumps, air conditioning, telephone junction boxes, transformers and traffic lights. Fire ants are notorious for their stinging behavior and cause localized intense burning and scarring in humans.

In this study, the repellent effect of racemic menthol propyleneglycol-carbonate was examined by preparing a solution of this chemical in ethanol at concentration of 50% (v/v). The solution was sprayed with a pump spray dispenser (Arminak & Associates, Duarte, Calif.) to a bait composed of sugary food (in this case, peanut butter). The control was composed of ethanol alone. This study was conducted in Fort Pierce, Fla. The protection time was measured as the time when the first ant started consuming the bait. The data in Table V show that bait sprayed with racemic menthol propyleneglycol-carbonate solution was protected from fire ants for at least 5 hours. The experiment was terminated after 5 hours of observation. Each study group was composed of 4 replicates. In the control which was sprayed with ethanol alone, the fire ants (s. invicta) were seen on the bait within 3 minutes after the spray was applied.

TABLE V

| | PROTECTION TIME | |
|---|---|---|
| Spray with ethanol alone (Control) | 3 | minutes |
| Spray with 50% Racemic menthol | >5 | hours |
| propyleneglycol-carbonate | | |

Effect of Entrapped Menthol Propyleneglycol Carbonate in Halloysite Clay in Repelling Mosquitoes.

This study was conducted to evaluate the suitability of encapsulation or entrapment as a means of reducing the amount of racemic menthol propyleneglycol-carbonate required to produce a repellent effect and to provide a means of protecting the active material from degradation by other excipients in the formulation or from high temperatures associated with manufacturing, as in the case of impregnation of textile materials. The halloysite clay represents an example of many other suitable encapsulation materials available in the industry and is not intended as a limitation of the scope of this invention.

Halloysite clay is a naturally derived, nontoxic, biodegradable material typically used in the manufacture of porcelain, bone china and fine china. U.S. Pat. No. 5,651,976 to Price and Gaber describes a new method of controlled release using microtubules made from halloysite clay. These microtubules are characterized as a cylinder with a hallow core of approximately 0.2 micrometers, which can be filled with an active compound, enabling slow release of active ingredients from the hollow core. The halloysite entrapped racemic menthol propyleneglycol-carbonate used in this study was supplied as a gift from Federal Technology Group (Bozeman, Mont.), with a total entrapped active material determined at 17% of the total weight. The control consisted of halloysite clay without the entrapped racemic menthol propyleneglycol-carbonate. Cosmetic formulation used in this study was an aloe vera moisturizing cream (General Nutrition Corp., Pittsburgh, Pa.). The halloysite entrapped racemic menthol propyleneglycol-carbonate was added to the moisturizing cream at a total concentration of 20% w/w, with the total active material in the formulation at 3.4%. In the halloysite control, halloysite without racemic menthol propyleneglycol-carbonate was added to the moisturizing cream at 20% w/w. A reference formulation was included which was composed of 20% w/w of racemic menthol propyleneglycol-carbonate in aloe vera cream, with aloe vera cream used as a control. These formulations were tested on human volunteers in the standard mosquito chamber test in which the formulation was applied on the forearm and inserted inside the chamber. Protection time was measured as the time at which the human subject experienced the first mosquito bite. Each study comprised three human volunteers.

The data recorded in Table VI show that incorporation of racemic menthol propyleneglycol-carbonate in halloysite clay reduced the total requirement for this active material, but produced essentially the same repellent effect. The protection time for the 20% racemic menthol propyleneglycol-carbonate cream was similar to that observed in 3.4% menthol propyleneglycol-carbonate entrapped in halloysite clay.

TABLE VI

| | PROTECTION TIME |
|---|---|
| | (Mean ± SEM) |
| Control aloe vera cream | 17 ± 4 |
| 20% racemic menthol propyleneglycol- | 93 ± 6 |
| carbonate in aloe vera cream | |
| Control halloysite cream | 30 ± 3 |
| 3.4% menthol propyleneglycol-carbonate | 95 ± 9 |
| entrapped in halloysite | |

### EXAMPLE 9

Effect of Racemic Menthol Propyleneglycol-Carbonate on Stable Flies

The stable fly or dog fly (Stomoxys calcitrans) is similar in size to houseflies and probably the most problematic insect pest in dairy cattle and other agricultural animals. Because of the popularity of horse breeding, these flies are now also a major problem in horse stables as well. Stable flies feed by piercing the skin and sucking the blood, causing pain and annoyance to farm animals. Stable fly infestation causes weight loss in cattle by as much as 25% and decrease in milk production by as much as 60%. In the absence of animals, stable flies will also attack humans.

To test the effectiveness of racemic menthol propylene glycol carbonate, a 50% solution was prepared in 95% ethanol and sprayed using a standard spray bottle. Stable flies were collected by placing a screened cage containing (Peaceful Valley Farm Supply, Grass Valley, Calif.) bait beside a horse stable one day prior to the test. Approximately 200 stable flies were collected from each cage. The test bait comprising pieces of beef was placed in an aluminum pan at the bottom of the collecting cage. The test was conducted using meat sprayed with 50% racemic menthol propyleneglycol-carbonate solution, with a control composed of meat sprayed with ethanol alone. The test was conducted in duplicate. The number of stable flies landing and feeding on the meat was counted periodically.

The data in Table VII below show that racemic menthol propyleneglycol-carbonate was effective in preventing stable flies from feeding on the treated meat. Although one or two flies landed on the treated meat, these flies did not linger to feed but moved on immediately. In the control group, the flies landed immediately and increased in numbers. The racemic menthol propyleneglycol-carbonate spray remained very effective for at least 5 hours and lost its efficacy by nine (9) hours from the initial single application.

TABLE VII
Effect of menthol propyleneglycol-carbonate spray on stable flies.

Number of flies landing on the bait

| TIME (minutes) | CONTROL | EXPERIMENTAL |
|---|---|---|
| 1 | 3 | 0 |
| 5 | 8 | 0 |
| 30 | 15 | 0 |
| 60 | >30* | 0 |
| 120 | >30 | 0 |
| 180 | >30 | 1 |
| 240 | >30 | 1 |
| 300 | 12 | 0 |
| 540 | >30 | >30 |

*The bait was extensively covered with flies and could not be counted accurately.

The data set forth in the foregoing examples indicate that compounds of Formula I, above, are effective as insect repellents.

A number of patent documents are cited in the foregoing specification in order to aid in describing the sate of the art to which this invention pertains. The entire disclosure of each of these citations is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope of the appended claims.

What is claimed is:

1. A method for repelling insects from a site which comprises applying to said site an insect repelling amount of a compound of the formula: 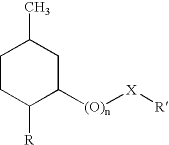
wherein R represents a straight or branched chain, substituted or unsubstituted lower alkyl radical, or a straight or branched chain, substituted or unsubstituted lower alkenyl radical;
X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0.

2. The method of claim 1 wherein the compound of Formula I is applied in the form of a composition, also including a suitable carrier, the amount of said compound being from about 1 wt % to about 80 wt % based on the total weight of said composition.

3. The method of claim 2, wherein the amount of said compound is from about 1 wt % to about 30 wt %, based on the total weight of said composition.

4. The method of claim 1, wherein the compound of Formula I is selected from the group consisting of menthol propyleneglycol-carbonate and isopulegol propyleneglycol-carbonate, said compound being in enantiomerically pure form or in racemic form.

5. The method of claim 1, wherein the compound of Formula I is racemic menthol propyleneglycol-carbonate.

6. The method of claim 1, wherein the compound of Formula I is isopulegol propyleneglycol-carbonate.

7. The method of claim 1 wherein said site is the integument of at least one living animal.

8. The method of claim 7 wherein said at least one living animal comprises humans.

9. The method of claim 7, wherein said at least one living animal comprises livestock.

10. The method of claim 7, wherein said site is the integument of a plant, plant part or seed.

11. An insect repellent composition comprising a compound of the formula: 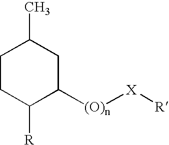
wherein R represents a straight or branched chain, substituted or unsubstituted lower alkyl radical, or a straight or branched chain, substituted or unsubstituted lower alkenyl radical;
X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0;
and a sustained release carrier.

12. The composition of claim 11, wherein said carrier is in the form of microtubles comprising halloysite clay.

13. A cosmetic or personal care composition, selected from the group of a perfume, cologne, deodorant, anti-perspirant, skin cream, soap, shampoo, hair conditioner, hair rinse, bath oil, talc, sunblock or sunscreen, said composition comprising a compound of the formula: 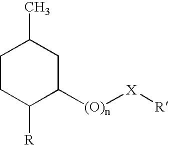
wherein R represents a straight or branched chain, substituted or unsubstituted lower alkyl radical, or a straight or branched chain, substituted or unsubstituted lower alkenyl radical;
X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0.

14. A household cleaning composition selected from the group of a cleanser, detergent, fabric softener or air freshener, said composition comprising a compound of the formula: 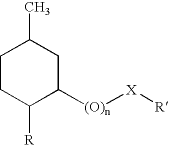
wherein R represents a straight or branched chain, substituted or unsubstituted lower alkyl radical, or a straight or branched chain, substituted or unsubstituted lower alkenyl radical; X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0.

15. An article of manufacture in the form of a fabric in which is incorporated a compound of the formula: 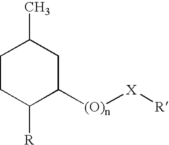
wherein R represents a straight or branched chain, substituted or unsubstituted lower alkyl radical, or a straight or branched chain, substituted or unsubstituted lower alkenyl radical;
X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0.

16. The article of claim 15, wherein said fabric is a non-woven, woven or knit fabric.

17. The article of claim 15, wherein said fabric is mosquito netting.

18. A method of rendering a fabric insect repellent, said method comprising incorporating into said fabric a compound of the formula: 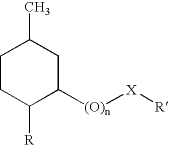
wherein R represents a straight or branched chain, substituted or unsubstituted lower alkyl radical, or a straight or branched chain, substituted or unsubstituted lower alkenyl radical;
X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0.

19. The method of claim 18, wherein said compound is incorporated into said fabric by spraying, impregnation or padding.

20. A coating composition comprising a compound of the formula: 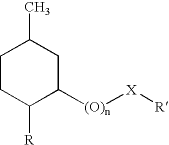
wherein R represents a straight or branched chain, substituted or unsubstituted lower alkyl radical, or a straight or branched chain, substituted or unsubstituted lower alkenyl radical;
X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is 0;
and a synthetic polymer film former.

21. A method for protecting an inanimate surface from infestation by insect pests said method comprising applying to said surface a coating composition comprising a compound of the formula: 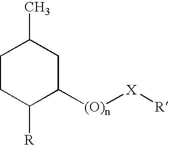
wherein R represents a straight or branched chain, substituted or unsubstituted lower alkyl radical, or a straight or branched chain, substituted or unsubstituted lower alkenyl radical;
X represents a carbonyl linking group (—C(═O)—) or a valence bond;
n is 0 or 1; and
R′ represents a radical selected from the group consisting of substituted or unsubstituted hydroxyalkyloxy and substituted or unsubstituted hydroxyalkyl, when n is 1; and R′ represents an alkylamine radical when n is O.

22. The method according to claim 18, wherein said coating composition is applied to said surface by brushing, spraying or dipping.
